(19) United States
(12) Patent Application Publication
(10) Pub. No.: US 2026/0091661 A1
(43) Pub. Date: Apr. 2, 2026

(54) Hybrid Power System for a Machine

(71) Applicant: Caterpillar Inc., Peoria, IL (US)

(72) Inventors: Jaspen PATENAUDE, Princeville, IL (US); David Jennings HAKES, Princeville, IL (US); Bradley Paul WRAGE, Pekin, IL (US); Daniel P. SERGISON, East Peoria, IL (US)

(73) Assignee: Caterpillar Inc., Peoria, IL (US)

(21) Appl. No.: 18/903,230

(22) Filed: Oct. 1, 2024

(51) Int. Cl. B60K 6/405; B60K 6/28; B60K 11/02

(52) U.S. Cl. CPC B60K 6/405; B60K 6/28; B60K 11/02

(57) ABSTRACT

A power system includes a mechanical module having an engine, a transmission, a cooling unit, and a motor-generator unit. The power system includes a frame connected to the mechanical module and removably connectable to a mount within a vehicle, such that the frame and the mechanical module are removable from the vehicle. The power system includes an electrical module having one or more batteries, a thermal management system, and one or more power electronics. The power system includes a housing which at least partially supports the electrical module. The housing includes feet that are releasably insertable into cleats connected to the vehicle, such that the housing and the electrical module are separately removable from the vehicle.

### TECHNICAL FIELD

The present disclosure relates generally to hybrid power systems, and more particularly, to a hybrid power system for a machine including an electric module and a mechanical module.

### BACKGROUND

Hybrid vehicles include hybrid power systems having components used to propel a vehicle via combustion and electrical power. Hybrid power systems, such as parallel hybrid system, may have increased power density over, fuel economy, and power over vehicles powered by either internal combustion or electrical power. Often, the components of the hybrid power systems are connected to the propulsion compartment of the hybrid vehicle such that removal of the components is difficult and time consuming. Moreover, the components are often connected to the hybrid vehicle in such a way that they may not be easily reinserted into the vehicle, or inserted into a different type of vehicle.

U.S. Pat. No. 10,940,903, published on Mar. 3, 2021 (“the '903 patent”), describes a modular military vehicle and a method for using a modular military vehicle. The engine bay of the vehicle can comprise a diesel engine, an electric generator, and at least one battery. In use, the diesel engine can spin the electric generator to power the driven wheels and to keep the at least one battery charged. Modular batteries can be placed within the engine bay in front of a crew compartment. The engine-generator system can be modular, and the battery system can be modular. For example, a first power module can comprise the engine and the generator, and a second power module can comprise the battery. As such, any system that fits within the space of the engine can be swapped in and out, as desired. As a modular system, the vehicle can operate in an engine mode without batteries, or conversely, entirely on battery power in a battery mode (for a limited duration). Brackets and fasteners can be used appropriately to join the various modules together. The various brackets and joint designs can be optimized to handle a load path and shearing forces induced on the joints as a result of impacts or vibrations. However, the '903 patent does not describe the packaging of the hybrid modules, or modules that may individually slide in and out of a propulsion compartment with limited connections to the hybrid vehicle and to the other modules of the hybrid power system.

The hybrid power system of the present disclosure may solve one or more of the problems set forth above and/or other problems in the art. The scope of the current disclosure, however, is defined by the attached claims, and not by the ability to solve any specific problem.

### SUMMARY

In one aspect, the disclosure relates to a hybrid power system for a vehicle. The hybrid power system may include a mechanical module having an engine, a transmission, a cooling unit, and a motor-generator unit. The hybrid power system may include a frame connected to the mechanical module and removably connectable to a mount within the vehicle, such that the frame and the mechanical module may be removable from the vehicle. The hybrid power system may include an electrical module having one or more batteries, a thermal management system, and one or more power electronics. The hybrid power system may include a housing that at least partially supports the electrical module. The housing may hay have feet that are releasably insertable into cleats connected to the vehicle, such that the housing and the electrical module may be separately removable from the vehicle.

In another aspect, the disclosure relates to a mechanical system for a hybrid power system for a vehicle. The mechanical system may include a mechanical module having an engine, a transmission, a cooling unit, and a motor-generator unit. The mechanical system may include a frame supporting the mechanical module. The frame may include a receiver having a slot with an inboard opening and an outboard end. The slot may slidably receive a pin of a mount connected to an engine compartment of the vehicle. The pin may be configured to prevent movement of the mechanical module in an outboard or vertical direction when at the outboard end of the slot.

In yet another aspect, the disclosure relates to an electrical system for a hybrid power system for a vehicle. The electrical system may include an electrical module having one or more batteries, a thermal managements system, and one or more power electronics. The electrical system may include a housing at least partially supporting the electrical module. The housing may have feet releasably insertable into cleats connected to the vehicle, such that the housing and electrical module may be removable from the vehicle.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a hybrid vehicle, according to aspects of the disclosure.

FIG. 2 depicts a hybrid power system of the hybrid vehicle of FIG. 1 engaged to isolation mounts.

FIG. 3 depicts the hybrid power system of the hybrid vehicle of FIG. 2, attached to a support frame and a housing.

FIG. 4 depicts a top perspective view of a portion of the hybrid power system FIG. 2.

FIG. 5 depicts a top perspective view of a frame that connects to the hybrid power system of FIG. 2, with the frame engaged to a mount.

FIG. 6A depicts a close up, perspective view of a connection assembly of the hybrid vehicle of FIG. 1, FIG. 6B depicts a close up, side view of the connection assembly of the hybrid vehicle of FIG. 1.

FIG. 7 depicts an electrical module of the hybrid power system of FIGS. 2 and 3.

FIG. 8A depicts a mounting element of the electrical module in a first position, and FIG. 8B depicts the mounting element of the electrical module in a second position.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. As used herein, the phrase “based on” is understood to be equivalent to the phrase “based at least on,” unless indicated otherwise. The term “or” is used disjunctively, such that “at least one of A or B” includes, (A), (B), (A and A), (A and B), etc.

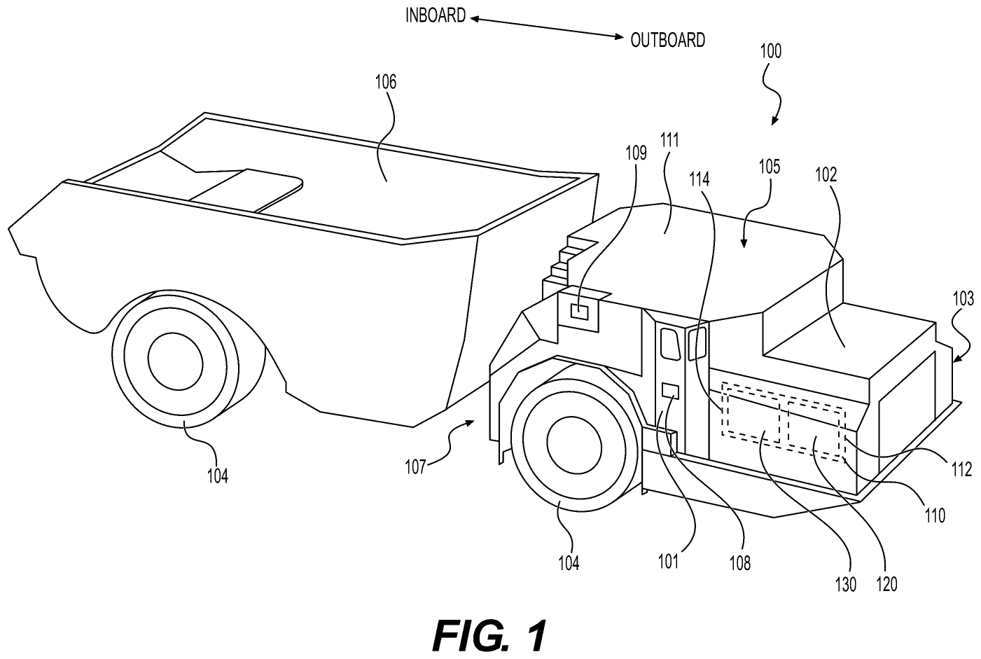

FIG. 1 depicts a hybrid vehicle 100, according to aspects of the disclosure. The hybrid vehicle 100 may include a chassis 111 and a bucket 106. The chassis 111 may further include a hybrid power system 110, having a mechanical module 120 and an electrical module 130. The mechanical module 120 and the electrical module 130 may each be removably inserted into a propulsion compartment 102 (e.g., an engine compartment) of the hybrid vehicle 100. In these aspects, either the mechanical module 120 or the electrical module 130 may be removed from the propulsion compartment 102 without affecting the operation of the other of the mechanical module 120 or the electrical module 130.

As shown in FIG. 1, the hybrid vehicle 100 may include a cab 101, the propulsion compartment 102, and ground engaging elements 104. Within the cab 101, the hybrid vehicle 100 may include one or more control elements 108, for example, pedals. The control elements 108 may include one or more of an accelerator pedal, a brake pedal, or a clutch pedal, depending on the vehicle. Additionally, the hybrid power system 110 may be within the propulsion compartment 102, as described in more detail below. The propulsion compartment 102 may be opened such that the interior of the propulsion compartment 102 and the hybrid power system 110 is accessible from, for example, a first, front end 103 of the hybrid vehicle 100 or from a top end 105 of the hybrid vehicle 100. The hybrid vehicle 100 may further include a controller 109 in electronic communication with the control elements 108 and the hybrid power system 110.

FIG. 1 depicts the hybrid vehicle 100 as an articulated haul truck, for example, including a chassis 111 and a bucket 106. Additionally, the ground engaging elements 104 are depicted as tires. In other examples, the hybrid vehicle 100 may be another type of large vehicle, such as a heavy duty truck, a bus, a track type vehicle, a mining vehicle, carthmoving vehicle, etc. Furthermore, in some examples, the ground engaging elements 104 may be another suitable vehicle propulsion system, such as one or more tracks (e.g., continuous track treads). Also in FIG. 1, the propulsion compartment 102 is depicted at the front end 103 of chassis 111. In other examples, the propulsion compartment 102 may be at the rear end 107 of the chassis 111 and the propulsion compartment 102 may be accessible from the rear end or from above, for example, when a door or other enclosure is opened. In other examples, the propulsion compartment 102 may be located at another end or side of the chassis 111 (e.g., the left or right end), and may be opened such that the propulsion compartment 102 is accessible from that end and from above. In some examples, the propulsion compartment 102 may be accessible from below in addition to, or instead of, from above. In further examples, the propulsion compartment 102 may be located on a portion of the hybrid vehicle 100 other than the chassis 111. For example, the 102 may be located under the bucket 106, and may be accessible from, for example, the rear or bottom of the bucket 106.

In the example of FIG. 1, the front end 103 may define an outboard end of the hybrid vehicle 100. Within the hybrid vehicle 100, the outboard direction may be a direction towards the front end 103, and the inboard direction may be a direction away from the front end 103. In other examples, the outboard direction may be defined by the end of the vehicle at which the propulsion compartment 102 is located. Within the hybrid vehicle 100 of such examples, the outboard direction may be towards the end of the vehicle at which the propulsion compartment 102 is located, and the inboard direction may be a direction away from that end of the vehicle. An inboard/outboard direction may be defined by an axis running in the inboard and outboard directions, and a lateral direction may be defined by an axis running transverse to the inboard/outboard direction and a vertical direction.

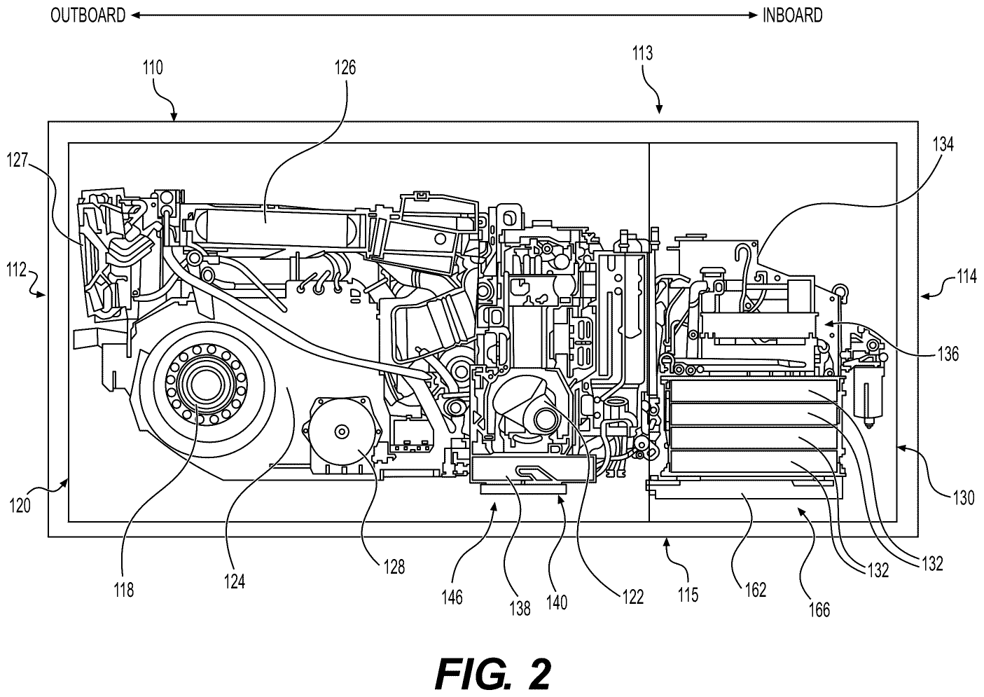

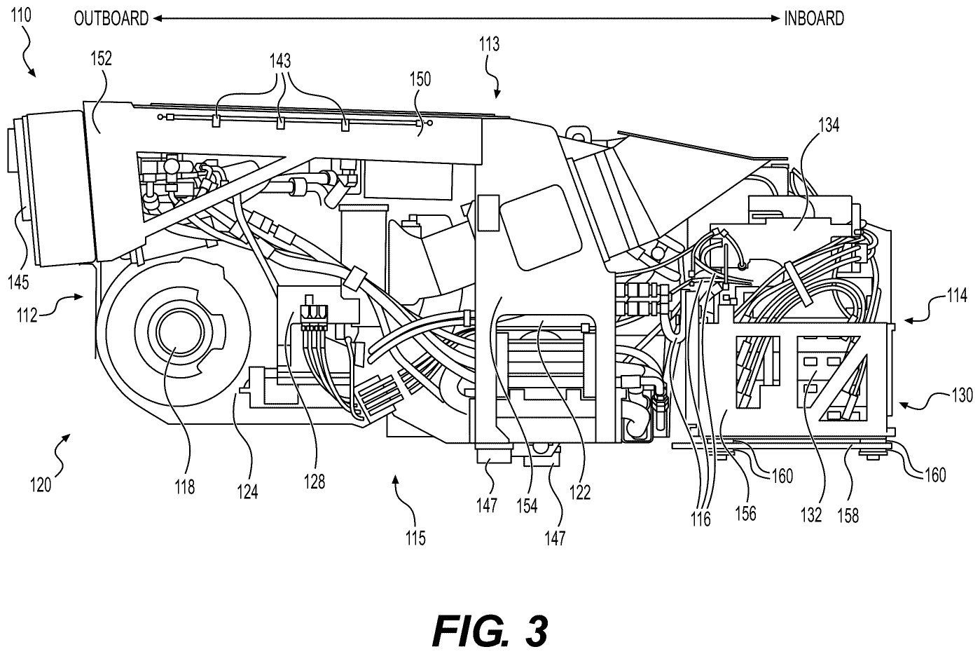

FIG. 2 depicts the hybrid power system 110 of the hybrid vehicle of FIG. 1 engaged to an isolation mount 140 and cleats 162. FIG. 3 depicts the hybrid power system 110 of the hybrid vehicle of FIG. 2 supported by a first, mechanical frame 150 and a second, housing 156. Referring now generally to FIGS. 2 and 3, the hybrid power system 110 may have a first, outboard end 112 and a second, inboard end 114 opposite the outboard end 112. When inserted within the propulsion compartment 102, the outboard end 112 may be nearest the front end 103 (FIG. 1) of the hybrid vehicle 100, and the inboard end 114 may be further away from the front end 103. The hybrid power system 110 may also include a top end 113 and a bottom end 115.

In various aspects, the hybrid power system 110 includes the mechanical module 120 and the electrical module 130. When inserted within the propulsion compartment 102 of the hybrid vehicle 100, the mechanical module 120 and the electrical module 130 may be linearly aligned. For example, the mechanical module 120 may be outboard of the electrical module 130. The mechanical module 120 may be connected to the electrical module 130 by one or more disconnectable umbilical cables or hoses, for example, umbilicals 116 (FIG. 3), extending between the mechanical module 120 and the electrical module 130. When connected, the umbilicals 116 may carry fluids or electricity between the mechanical module 120 and electrical module 130 such that the mechanical module 120 and the electrical module 130 are in fluid or electronic communication. When the umbilicals 116 are disconnected, such that there is no fluid or electronic communication between the mechanical module 120 and the electrical module 130, one or more of the umbilicals 116 may be connected to external equipment to run (e.g., provide fluid, electrical energy, electronic communication, etc. to) the mechanical module 120 or the electrical module 130. The umbilicals 116 may include cooling umbilicals, fuel umbilicals, low voltage electrical umbilicals, high voltage electrical umbilicals, or other umbilicals. Other examples may use other combinations or types of umbilicals.

The mechanical module 120 may include an engine 122 and a transmission 124, and the engine 122 may be inboard of the transmission 124. The engine 122 may be connected to the transmission 124 via one or more shafts (not shown) extending between engine 122 and the transmission 124. The mechanical module 120 may also include a cooling system 126, which may be positioned above the transmission 124. The mechanical module 120 may also include a motor-generator unit (“MGU”) 128, which may be positioned on a lateral end of the transmission 124, for example, outboard of the engine 122. The MGU 128 may be connected to both the engine 122 and the transmission 124 by the one or more shafts (not shown), such that the engine 122, transmission 124, and MGU 128 are mechanically connected. The cooling system 126 may include one or more fans 127 at the outboard end 112 of the hybrid power system 110. The components of the mechanical module 120 (e.g., engine 122, transmission 124, and MGU 128) may be connected to each other or a support structure, mechanical frame 150, such that mechanical module 120 may form a single unit connected to, and supported by, the mechanical frame 150. As such, the mechanical module 120 may move as a whole with the mechanical frame 150 when the mechanical module 120 is coupled to the mechanical frame.

As discussed further below, the mechanical frame 150 may include an upper mechanical frame 152 and a lower mechanical frame 154. When inserted into the propulsion compartment 102, the mechanical module 120 of the hybrid power system 110 may be connected to a final drive 118 fixed to the hull of the vehicle 100. The final drive 118 may extend into the propulsion compartment 102. Additionally, the mechanical frame 150 may slidably connect to an isolation mount 140 (explained further below, and depicted in FIG. 2). In these aspects, the mechanical module 120 may be supported by the final drive 118 and the isolation mount 140 via the frame 150.

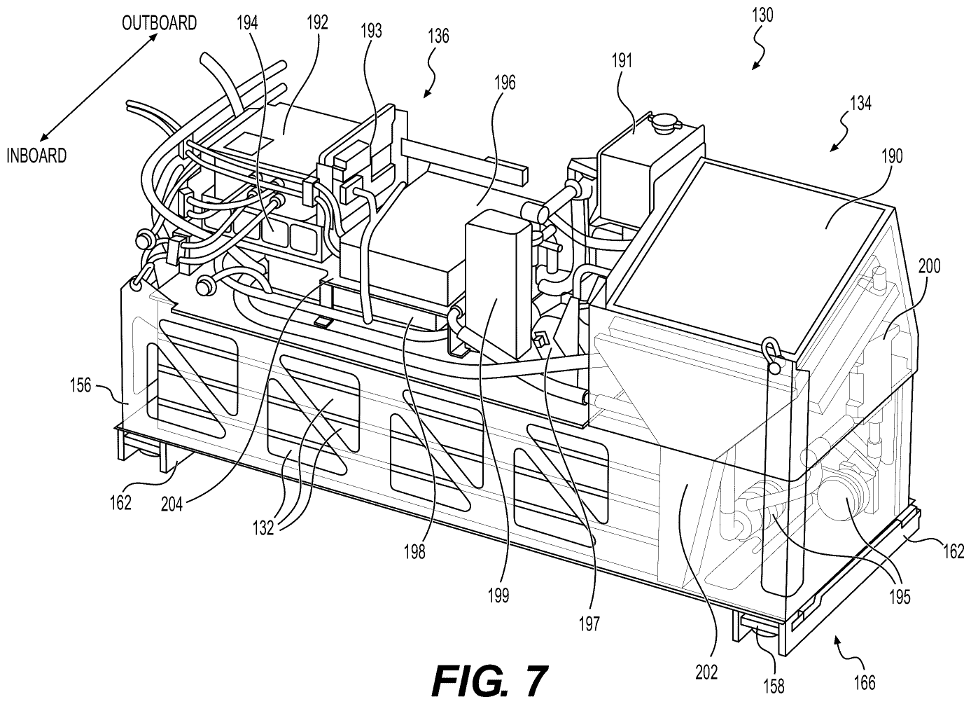

The electrical module 130 may include one or more batteries 132, a battery thermal management system (“BTMS”) 134, and power electronics 136 (FIG. 7). The BTMS 134 may be positioned at a lateral side of the batteries 132, and the power electronics 136 may be positioned above the batteries 132. The electrical module 130 may be at least partially encompassed or surrounded by the housing 156, such that the housing 156 at least partially supports the electrical module 130. The components of the electrical module 130 (e.g., one or more batteries 132, BTMS 134, and power electronics 136) may be connected to one another and the housing 156, such that the electrical module 130 forms a single unit connected to, and supported by the housing 156. Fect 158 (FIG. 3) may be connected to the housing 156, and may extend along the bottom of the electrical module 130 in the inboard/outboard direction. Isolation mounts or pads 160 may be positioned on either side of the feet 158, between the inboard and outboard end of the electrical module 130. As will explained further below, the feet 158 may be releasably inserted into cleats 162 to connect and secure the housing 156 and attached electrical module 130 to the propulsion compartment 102 of the hybrid vehicle 100.

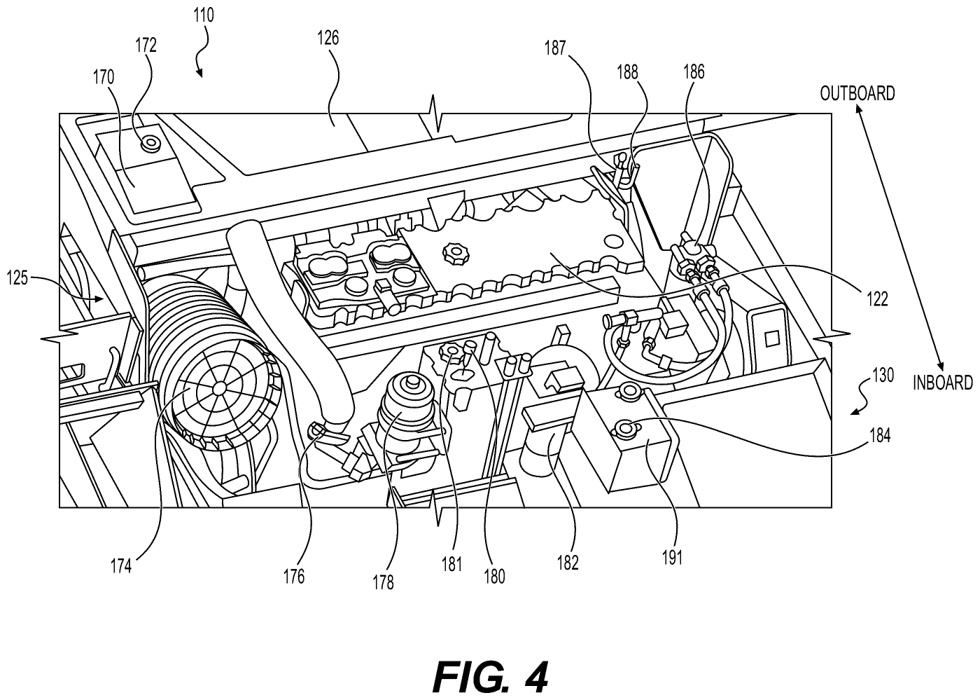

FIG. 4 depicts a top perspective view of a portion of the hybrid power system 110 of the hybrid vehicle of FIG. 2. As can be seen in FIG. 4, the hybrid power system 110 may have a service port zone 125 having a number of number of service ports (e.g., ports, tanks, and filters) arranged at or near the top end 113 of the hybrid power system 110. For example, the service ports in the service port zone 125 of the mechanical module 120 may include one or more of a shunt tank 170 with a tank opening 172, an air filter 174, a coolant tank opening 176, an oil filter 178, an engine dipstick 180, an engine fill port 181, fuel filters 182, a coolant filter 186, a transmission dipstick 187, or a transmission fill port 188, all accessible from the top end 113 of the hybrid power system 110. The service ports of the electrical module 130 may include a BTMS shunt tank 191 having a shunt tank opening 184 accessible from the top end 113 of the hybrid power system 110.

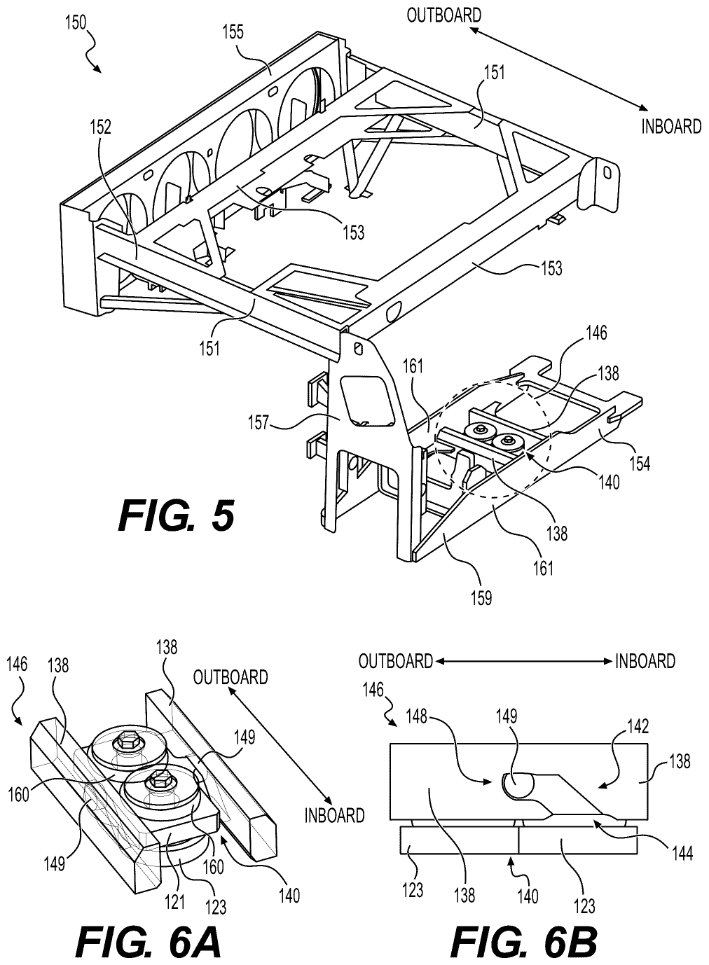

FIG. 5 depicts the frame 150 of the mechanical module of FIG. 4 engaged to an isolation mount 140. The upper mechanical frame 152 may be generally rectangular. For example, upper mechanical frame 152 may include side walls 151 that extend from an inboard end to an outboard end of the mechanical frame 150 along the inboard/outboard direction. Additionally, upper mechanical frame 152 may include lateral walls 153 that extend laterally between the side walls 151 at both the inboard end and the outboard end of the mechanical frame 150. The mechanical frame 150 may also include a housing 155, for example, for the one or more fans 127 (FIG. 2) of the cooling system 126 at the outboard end of the mechanical frame 150. The upper mechanical frame 152 may attach to a housing of the transmission 124 and generally surround the cooling system 126.

The lower mechanical frame 154 includes a vertical arm 157 that connects to the upper mechanical frame 152. The lower mechanical frame 154 also includes a base 159 for supporting the engine 122. The base 159 may include one or more lateral supports 161 spaced from one another along the inboard/outboard direction. One or more receivers 138 may extend between the lateral supports 161. The receiver(s) 138 may combine with the isolation mount(s) 140 attached to the floor of the propulsion compartment 102 to form a first mounting assembly 146.

In some examples, the upper mechanical frame 152 and the lower mechanical frame 154 may be bolted together. Such a connection may minimize the sizing tolerances needed assembly. In other examples, the mechanical upper mechanical frame 152 and lower mechanical frame 154 may be welded or otherwise attached or coupled together. In certain examples, the upper mechanical frame 152 and the lower mechanical frame 154 may be formed as a single component. In some examples, the upper mechanical frame 152 or the lower mechanical frame 154 may comprise a number of individual pieces bolted, welded, or otherwise attached or coupled to one another. In other examples, the upper mechanical frame 152 may be formed from a single component, or the lower mechanical frame 154 may formed from a single component.

The mechanical frame 150 may further include bump stops. For example, as shown in FIG. 3, the mechanical frame 150 may include one or more rear bump stops 145 or one or more bottom bump stops 147. The bump stops 145, 147 may help to limit deflection of the mechanical frame 150 into the hull of the hybrid vehicle 100. The mechanical frame 150 may have features, such as clipping points 143, for attaching various cables and tubes of the hybrid power system 110 to the mechanical frame 150.

FIGS. 6A and 6B depict a close up, perspective view and a close up, side view of the first mounting assembly 146 of the vehicle of FIG. 1, respectively. As shown in FIG. 6B, the receivers 138 of the lower mechanical frame lower mechanical frame 154 may each include a slot or groove 142 having an inlet end 144 and an outboard end 148. The outboard end 148 of the groove 142 may lay along the inboard/outboard direction, such that the groove 142 is generally aligned with the inboard/outboard longitudinal direction. The inlet end 144 may be angled relative to the inboard/outboard direction, such that the inlet end is open towards the bottom end 115 (FIGS. 2 and 3) of the hybrid power system 110. The isolation mount 140 may include a horizontal plate element 121, and one or more circular base elements 123. Pads 160 may be positioned between the horizontal plate element 121 and the one or more circular base elements 123. Pads 160 may also be positioned atop the 121, so as to separate the 121 from the engine 122. The isolation mount 140 may further include pins 149 that extend outward from either lateral side of the plate element 123. As explained further below, when the mechanical module 120 is inserted into the propulsion compartment 102 of the hybrid vehicle 100, the pins 149 may be engaged within the grooves 142 of the receivers 138, connecting the frame 150 to the hybrid vehicle 100.

FIG. 7 depicts the electrical module of the hybrid power system of FIGS. 2 and 3. As shown in FIG. 7, the one or more batteries 132 may include a plurality of batteries that may generally extend laterally, for example, with some batteries along the bottom of the electrical module 130 within the housing 156. The batteries 132 may be generally flat, and at least some of the batteries may be stacked upon one another. The power electronics 136 may be positioned above the one or more batteries 132, and may include, for example, one or more of a power distribution unit (“PDU”) 192, an engine control module (“ECM”) 193, a power inverter 194, a converter 196, or a charger 198. In some embodiments, the power electronics 136 may include one or more of the PDU 192, the ECM 193, or the power inverter 194. In some embodiments, the power electronics 136 may optionally include the converter 196 or the charger 198. The converter 196 may be a DC converter or another type of converter. The charger 198 may be a DC charger or another type of charger. The power electronics 136 may be stacked in columns. For example, the PDU 192 may be stacked on top of the power inverter 194, which may be stacked above at least a portion of the charger 198. The converter 196 may be stacked above another portion of the charger 198, between the power inverter 194 and the BTMS 134. The PDU 192, ECM 193, power inverter 194, converter 196, or charger 198 may be attached to a support structure 204 connected to the top of the housing 156. In other embodiments, the arrangement of the power electronics 136 may be different.

The BTMS 134 may be generally lateral to the batteries 132 and the power electronics 136. The BTMS 134 may include one or more of a condenser 190, the BTMS shunt tank 191, water pump(s) 195, a compressor 197, an evaporator 199, a water heater 200, or a vent stack 202. In some embodiments, the BTMS 134 may include one or more of the condenser 190, the BTMS shunt tank 191, water pump(s) 195, the compressor 197, the evaporator 199, or the vent stack 202. In some embodiments, the BTMS 134 may optionally include the water heater 200. The water pump(s) 195, water heater 200, and vent stack 202 may be arranged within the housing 156 at a lateral end of the batteries 132. The vent stack 202 may be attached to an inboard end of the housing 156, and the water pump(s) 195 may be attached to the housing outboard of the vent stack 202. The condenser 190 may be arranged within the housing 156 above the water pump(s) 195, water heater 200, and vent stack 202. The BTMS shunt tank 191, compressor 197, and evaporator 199 may be arranged above the batteries 132, between the power electronics 136 and the condenser 190. The shunt tank 191 may be attached to the condenser 190, and the compressor 197 may be attached to the top of the housing 156 above the batteries 132. The evaporator 199 may be attached to the support structure 204. In other embodiments, the arrangement of the BTMS 134 may be different.

One or more feet 158 may be connected to the bottom of the housing 156. The feet 158 and the cleats 162 together may form a second mounting assembly, mounting assembly 166.

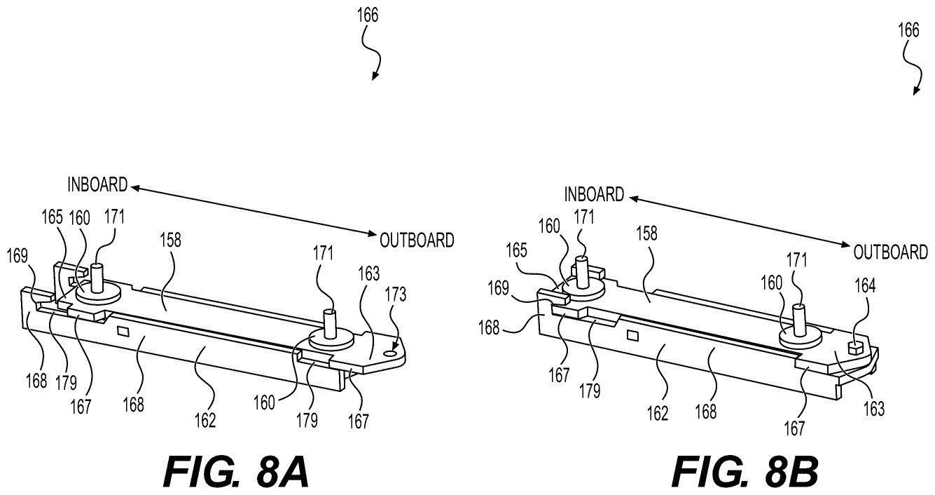

FIG. 8A depicts the mounting assembly 166 in a first, disengaged position, and FIG. 8B depicts the mounting assembly 166 in a second, engaged position. As shown in FIGS. 8A and 8B, the fect 158 may have an outboard end 163 and an inboard end 165. Feet 158 may each include one or more tongues 167. For example, each foot 158 may include four tongues 167, with two tongues 167 at the outboard end 163 and tongues 167 at the inboard end 165. Each of the tongues 167 may extend laterally away from the respective foot 158, with one tongue at each end 163, 165 of the feet 158 extending in either lateral direction. The outboard ends 163 of the feet 158 may each include a hole 173 for receiving vertical structural element 171. The feet 158 may be connected to the housing 156 using vertical structural element 171. Pads 160 may be placed or otherwise positioned between the feet 158 and the housing 156, as well as below the feet 158, such that they surround vertical structural element 171. In the example shown in FIGS. 8A and 8B, the vertical structural element 171 may be bolts that couple the feet 158 to the housing 156. In other examples, 171 may be other structures that prevent or reduce lateral or vertical motion of the housing 156 relative to the feet 158.

The cleats 162 may have sets of raised wall portions 168 inboard of lower rail portions 179. The inboard most raised portions 168 may each include a slot 169 extending inboard for receiving the inboard tongues 167 of the feet 158. The cleats may further include a hole (not show) that aligns or adjoins the hole 173 when the feet 158 are in the engaged position.

In a disengaged position (FIG. 8A), the feet 158 may move in a vertical or inboard direction relative to the cleats 162. In an engaged position (FIG. 8B), the mounting assembly 166 the inboard tongues 167 of the feet 158 may be within the slots 169 of the inboard raised wall portions 168. When in the engaged position, a bolt 164 may be used to connect the fect 158 to the cleats 162 so as to help prevent relative movement between the feet 158 and the cleats 162.

The hybrid power system 110 may form, at least in part, a parallel hybrid powertrain of the hybrid vehicle 100. In use, the engine 122 or the MGU 128 may be used to propel the hybrid vehicle 100. The engine 122 and the MGU 128 may both be connected to the transmission 124, such that either or both the engine 122 or the MGU 128 may be used to drive the gears of the transmission 124, which may transmit rotational energy to the ground engaging elements 104 via the final drive 118. The combustion of fuel within the engine 122 may rotate a shaft (not shown) connected to the transmission 124, while the one or more batteries 132 may be used to power the MGU 128, which may also turn a shaft (not shown) connected to the transmission 124.

### INDUSTRIAL APPLICABILITY

The disclosed aspects of the hybrid power system 110 of the present disclosure may be used to streamline the design of a hybrid powertrain of a hybrid vehicle while making it easier to remove and repair modules of the hybrid powertrain.

The slide in design of the mechanical module 120 and electrical module 130 of the hybrid power system 110 help to allow each module 120, 130 to be easily removed for repair, and then reinserted, and for the mechanical module 120 and the electrical module 130 to be independently attached to the hybrid vehicle 100. Often times, the mechanical components of a hybrid drive train require more frequent inspection, repair, or other maintenance. Because the mechanical module 120 is outboard of the electrical module 130, the mechanical module 120 may be easily removed from the propulsion compartment 102 of the hybrid vehicle 100 without removing the electrical module 130 from the propulsion compartment 102. Further, as the mechanical module 120 is attached to the vehicle only at the final drive 118 and the isolation mount 140, and to the electrical module 130 via disconnectable umbilicals 116, the mechanical module 120 may be quickly disconnected from the electrical module 130 and removed from the propulsion compartment 102 of the hybrid vehicle 100 for repair. When either or both of the mechanical module 120 or electrical module 130 are removed from the propulsion compartment 102, the mechanical module 120 or electrical module 130 may be ground hopped via the umbilicals 116, such that the mechanical module 120 or electrical module 130 may be run while outside of the propulsion compartment 102. The location of the ports and openings at the top end 113 of the hybrid power system 110 allow the hybrid power system 110 to be quickly serviced within the propulsion compartment 102.

Referring again to FIGS. 8A and 8B, to insert the hybrid power system 110 into the propulsion compartment 102 of the hybrid vehicle 100, the housing 156 connected to the electrical module 130 may be lowered or otherwise inserted into the propulsion compartment 102, such that the fect 158 are on top of the lower rail portion 179 of the cleats 162, as shown in FIG. 8A. The housing 156 connected to the electrical module 130 may then be pushed or otherwise moved in an inboard direction, such that fect 158 slide along the lower rail portion 179 until the mounting assembly 166 is in the engaged position, as shown in FIG. 8B. When the mounting assembly 166 is in the engaged position, the inboard tongues 167 of the feet 158 are within the slots 169 of the inboard raised wall portions 168 of the cleats 162. Once in the engaged position, the bolt 164 may be inserted into the hole 173 to connect the cleats 162 to the fect 158. The cleats 162 may have a hole that adjoins hole 173 in the engaged position, through which the bolt 164 may pass. To remove the electrical module 130, the process may be reversed.

When the inboard tongues 167 of the feet 158 are within the slots 169 of the cleats 162, the interaction of the inboard tongues 167 with the slots 169 may help to limit the vertical and inboard motion of the housing 156 and the attached electrical module 130. Further, the vertical structural element 171 connecting the feet 158 to the cleats 162 may help to limit the motion of the housing 156 and the electrical module 130 in the vertical and inboard/outboard directions. The pads 160 may also help to absorb the vertical motion of the housing 156 and the attached electrical module 130.

In the examples described above, the feet 158 are described as fixed to the housing. In other examples, the feet 158 may be separate from the housing. In such examples, the housing may be lowered onto the vertical structural element 171 when inserted into the propulsion compartment 102, such that the 158 remain within the cleats 162 when the housing 156 and the electrical module 130 are removed from the hybrid vehicle 100.

Referring again to FIGS. 6A and 6B, to insert the mechanical module 120 into the propulsion compartment 102 of the hybrid vehicle 100, the mechanical frame 150 and the attached mechanical module 120 may be lowered into propulsion compartment 102 such that the pins 149 of the isolation mount 140 are received within the inlet end 144 of the groove 142. The mechanical frame 150 and the attached mechanical module 120 may then be pushed or otherwise moved in an inboard direction such that the pins 149 are at the outboard end 148 of the groove 142. To remove the mechanical module 120 the process may be reversed.

When the pins 149 are at the outboard end 148 of the groove 142, the pins 149 may help to limit the vertical and inboard motion of the mechanical frame 150 and the attached mechanical module 120 relative to the hybrid vehicle 100. The isolation mount 140 may also help to absorb vertical motion of the mechanical frame 150 and the attached mechanical module 120. Once the mechanical frame 150 and the attached mechanical module 120 are within the propulsion compartment 102, the umbilicals 116 may be connected, such that power and fluid may flow between the mechanical module 120 and the electrical module 130.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

1. A hybrid power system for a vehicle, the hybrid power system comprising:
a mechanical module, the mechanical module including:
an engine,
a transmission,
a cooling unit, and
a motor-generator unit,
a frame connected to the mechanical module and removably connectable to a mount within the vehicle, such that the frame and the mechanical module are removable from the vehicle,
an electrical module, the electrical module including:
one or more batteries,
a thermal management system, and
one or more power electronics, and
a housing at least partially supporting the electrical module, the housing having feet that are releasably insertable into cleats connected to the vehicle, such that the housing and the electrical module are separately removable from the vehicle.

2. The hybrid power system of claim 1, wherein the mechanical module and the electrical module are linearly aligned in an engine compartment when inserted into the vehicle, and wherein the mechanical module is outboard of the electrical module when inserted into the vehicle.

3. The hybrid power system of claim 1, wherein the frame includes a receiver having a slot with an inboard opening and an outboard end, wherein the slot slidably receives a pin on the mount, the pin preventing movement of the mechanical module in an outboard or vertical direction when at the outboard end of the slot.

4. The hybrid power system of claim 1, wherein, when the mechanical module is inserted within the vehicle, the frame connects to the mount and the mechanical module connects to a final drive of the vehicle.

5. The hybrid power system of claim 1, wherein the feet include one or more tongues extending laterally away from the feet, and wherein the one or more tongues are slidably received in grooves within the cleats when the electrical module is inserted into the vehicle.

6. The hybrid power system of claim 1, wherein the mechanical module and the electrical module are connected by one or more disconnectable umbilicals.

7. The hybrid power system of claim 1, wherein the hybrid power system includes at least one service port zone accessible from a top end of the mechanical module, and wherein the at least one service port zone includes one or more of: a shunt tank with a tank opening, an air filter, a coolant tank opening, an oil filter, an engine dipstick, an engine fill port, fuel filters, a coolant filter, a transmission dipstick, or a transmission fill port.

8-20. (canceled)

21. The hybrid power system of claim 1, wherein, when the housing and the electrical module are separately removed from the vehicle, the electrical module is configured to be ground hopped via one or more umbilicals, such that the electrical module can be run while outside of the vehicle.

22. The hybrid power system of claim 21, wherein the one or more umbilicals include one or more cooling umbilicals, one or more fuel umbilicals, one or more low voltage electrical umbilicals, and one or more high voltage umbilicals.

23. A hybrid power system for a vehicle, the hybrid power system comprising:
a mechanical module, the mechanical module including:
an engine,
a transmission,
a cooling unit, and
a motor-generator unit,
a frame connected to the mechanical module and removably connectable to a mount within the vehicle, such that the frame and the mechanical module are removable from the vehicle,
an electrical module, the electrical module including:
one or more batteries,
a thermal management system, and
one or more power electronics, and
a housing at least partially supporting the electrical module, wherein the electrical module and the housing are separately removable from the vehicle while the mechanical module and the frame remain within the vehicle, and wherein the mechanical module and the frame are separately removable from the vehicle while the electrical module and the housing remain within the vehicle.

24. The hybrid power system of claim 23, wherein, when the housing and the electrical module are separately removed from the vehicle, the electrical module is configured to be ground hopped via one or more umbilicals, such that the electrical module can be run while outside of the vehicle.

25. The hybrid power system of claim 24, wherein the one or more umbilicals include one or more cooling umbilicals, one or more fuel umbilicals, one or more low voltage electrical umbilicals, and one or more high voltage umbilicals.

26. The hybrid power system of claim 23, wherein the housing includes a plurality of feet that are releasably insertable into cleats connected to the vehicle, and wherein each of the plurality of feet include an inboard end, an outboard end, and tongues at the inboard end and outboard end, wherein the tongues extend laterally outward, wherein the tongues at the inboard end are received within a groove of one cleat, wherein the electrical module further includes a bolt, and wherein the bolt is received within the outboard end of each of the plurality of feet when the electrical module is inserted into the vehicle.

27. A hybrid power system for a vehicle, the hybrid power system comprising:
a mechanical module, the mechanical module including:
a transmission,
an engine, and
a motor-generator unit,
a frame connected to the mechanical module and removably connectable to a mount within the vehicle, such that the frame and the mechanical module are removable from the vehicle,
an electrical module, the electrical module including:
one or more batteries,
a thermal management system, and
one or more power electronics, and
a housing at least partially supporting the electrical module, wherein the electrical module and the housing are separately removable from the vehicle while the mechanical module and the frame remain within the vehicle, and wherein the electrical module and the housing are positioned inboard of the mechanical module and the frame when positioned within the vehicle.

28. The hybrid power system of claim 27, wherein the mechanical module includes a cooling unit, wherein the engine is positioned inboard of the transmission, wherein the cooling unit is positioned above the transmission, and wherein the motor-generator unit is positioned on a lateral end of the transmission.

29. The hybrid power system of claim 28, wherein the mechanical module is movable as a whole with the frame when the mechanical module is coupled to the frame.

30. The hybrid power system of claim 28, wherein the cooling unit includes one or more fans, wherein the one or more fans are positioned at an outboard end of the hybrid power system.

31. The hybrid power system of claim 27, wherein the thermal management system is positioned lateral to the one or more batteries and to the one or more power electronics.

32. The hybrid power system of claim 31, wherein the frame includes an upper frame and a lower frame, and wherein the lower frame includes one or more vertical arms that connect the lower frame to the upper frame.

33. The hybrid power system of claim 31, wherein the thermal management system includes a condenser, a water pump, a compressor, an evaporator, a water heater, and a vent stack, wherein the water pump, the water heater, and the vent stack are arranged at a lateral end of the one or more batteries, wherein the vent stack is attached to an inboard end of the housing, wherein the water pump is attached to the housing at a position outboard of the vent stack, and wherein the condenser is arranged within the housing at a position above the water pump, the water heater, and the vent stack, and wherein the compressor and the evaporator are positioned above the one or more batteries.
